(19) United States
(12) Patent Application Publication
(10) Pub. No.: US 2007/0231227 A1
(43) Pub. Date: Oct. 4, 2007

(54) Lamellar Iron-III-Oxide

(75) Inventors: Andreas Henckel Von Donnersmarck, Wolfsberg (AT); Berndt Bohme, Wolfsberg (AT)

Correspondence Address: LERNER GREENBERG STEMER LLP, P O BOX 2480, HOLLYWOOD, FL, 33022-2480, US

(73) Assignee: Kamtner Montanindustrie Gesellschaft m.b.H.

(21) Appl. No.: 11/630,234

(22) PCT Filed: Jun. 24, 2005
(86) PCT No.: PCT/AT05/00231

§ 371 Date: Dec. 20, 2006

(30) Foreign Application Priority Data
Jun. 24, 2004 (AT) A 1077/2004
Jun. 21, 2005 (AT) GM 413/2005

(51) Int. Cl. C01G 49/00

(52) U.S. Cl. 423/138; 423/633

(57) ABSTRACT

An iron(III) oxide has a lamellar structure of at least 50% by weight, preferably at least 75% by weight. We also describe a method for producing lamellar iron(III) oxide, and the use of the novel lamellar iron oxide.

The invention relates to iron(III) oxide which has a lamellar structure of at least 50% by weight, preferably 75% by weight.

The invention further relates to a method for producing lamellar iron(III) oxide.

Furthermore, the invention relates to the use of lamellar iron(III) oxide.

Iron(III) oxide typically has the form of red to black crystals. The paramagnetic modification in mineralogy is called hematite. Hematite can exhibit fine-scale-like, platy, plate-like or also compact crystals, or grains, respectively, or particles. On account of the fine-scale-like, platy, plate-like form, iron(III) oxide is commercially known under the name iron mica (Fe mica).

In the present instance, the lamellar structure is understood to be the fine-scale-like, platy, plate-like structure of the iron(III) oxide.

Iron(III) oxide is used in many fields of application in which this structure is useful. This particularly holds for films, coats of paint, coatings of various types, the iron(III) oxide as a pigment often being admixed with an appropriate binder and applied to a substructure, such as, for instance, outdoor steel structures. Due to the presence of the lamellar iron(III) oxide particles, the coating develops a barrier effect, a shielding effect, a higher abrasion resistance and an intensified colour film. By barrier effect and shielding effect, usually the resistance of coatings is to be understood. In general, it is achieved in that when the coating is applied to the substructure, the plate-like iron(III) oxide particles substantially orient themselves in parallel with the surface of the substructure and partially overlap each other. This lengthens the path of the “permeant”, and the penetration of, e.g. corrosively acting substances (“permeant”) is, thus, retarded (barrier effect). Likewise, rapid damage to the substructure and also to the binder by further environmental influences, such as UV, IR radiation—wherein the radiation is deflected, or reflected, respectively, by/on the plate-like particles—, temperature fluctuations, are avoided (shielding effect).

An additional positive effect consists in the increased load bearing capacity with regard to a mechanical wear. By evaporation of the solvents of the coating, humidification and drying as well as by a mechanical wear, a conventional coating will quickly be adversely affected and damaged. Reinforcement by means of lamellar iron(III) oxide contained in the coating will counteract such wear.

So far, however, there has been the problem that natural iron(III) oxide could merely be provided in a particle size of up to 60 or 50 μm while retaining its lamellar structure. At best, the particle size could be reduced to 30 μm, since only particles larger than 30 μm have undamaged lamellae. Therefore, the aforementioned advantages of lamellar iron(III) oxide so far could only be utilised in case of particles sizes of larger than 30 μm. Even though a sieve residue smaller than 30 μm of iron(III) oxide can be further used in small amounts, it is, however, considered as reject. In particular, iron(III) oxide of smaller particle size is not considered to be meaningful in coatings, since so far it has been present as a mixture of grains having a very low portion of particles of lamellar structure, and the positive properties attributed to the lamellar structure did not show to advantage.

In a data sheet of Applicant published prior to the present application and regarding natural Fe mica designated “MIOX MICRO-Serie”, products (MICRO 30, MICRO 40, MICRO 50) mainly to be used in coatings are described, which have a sieve residue of 2% at 32 μm, at 40 μm and at 50 μm with a lamellar portion of 90% of the samples investigated. The grain sum curve—the graphical representation of the grain size distribution—belonging to the sample having the smallest upper grain (MICRO 30) shows that a very small portion of the grains in this sample are in the fine range.

Similar iron oxide products are known from JP 2 194 072 A as well as from JP 61 031 318 A.

In the prior art, natural Fe mica is said to have further disadvantages, particularly when employed in the field of coatings. The scientific articles published in the name of MPLC Laboratories Ltd., Peterlee, U.K. “Production of synthetic lamellar iron oxide for use as a pigment in protective coatings”, by E. V. Carter and R. D. Laundon, and “Synthetic lamellar iron oxide: a new pigment for anti-corrosive primers” by E. Carter, mention is made of an unintentionally high portion of granular grains and morphologically irregularly formed grains of the natural Fe mica and of undesired impurities in a sample, i.e. accompanying minerals, such as, e.g., sulphurous minerals, such as pyrite, silicates, carbonates, which have a negative effect on the corrosion resistance, adhesive power with the binder used, durability and, thus, reliability of coatings.

Therefore, it has been suggested to provide synthetic iron(III) oxide which shall also prevent said disadvantages of natural Fe mica. In most cases, it is conventional chemical methods which are employed for producing synthetic plate-like Fe mica particles, such as, e.g., have also been discussed in the scientific articles previously mentioned.

JP 2 024 364 A describes the production of a magnetic iron oxide pigment from iron oxide particles having a diameter of from 5 to 200 μm and a thickness of approximately 0.1 to 5 μm, which are reduced in a special formulation under reducing gas conditions and subsequently are oxidised to magnetic iron oxide.

Synthetic Fe mica in most cases are disadvantageous since the methods for their production involve hight costs, are complex and not multifunctional. Without process-technological changes or changeovers of the installations, often only mono-grains, i.e. plate-like Fe mica particles, of substantially the same or similar grain size can be provided.

It is now an object of the invention to provide iron(III) oxide in lamellar structure for a broad range of applications and at low costs, wherein the content of lamellar particles in the broader yet also in the finer range of grain sizes shall be provided.

According to the invention, this object is achieved in that the iron(III) oxide is a mechanically processed iron(III) oxide of natural origin, and in that at least 50% by weight, preferably at least 70% by weight, particularly preferably 90% by weight, of the iron(III) oxide are provided in a particle size of smaller than 10 μm.

According to the invention, mechanically processed iron(III) oxide may be micronised, i.e. ground. Preferably, the mechanical processing is carried out by means of the methods listed below.

According to the invention, iron(III) oxide of natural origin means that the iron particles are taken from natural sources, primarily from natural deposits.

A final product having an increased portion of lamellar iron(III) oxide of a particle size of smaller than 10 μm increases in quality and applicability. This does not only apply to fields of industry in which thin film coatings are important, but generally to the application in films or coatings. Based on the fine grain size and the grain size distribution of the plate-like particles, alignment and overlapping of the plate-like particles during application of the coating on a substructure to be coated can occur easily and quickly. Alignment of the individual, differently sized plate-like particles substantially in parallel with the surface of the substructure, is only aggravated by a “transversely arranged”, “upright” grain, i.e. a grain which is not aligned in the desired orientation. The undesired orientation of this grain can be automatically “corrected” by alignment of another, adjacent plate-like particle. Moreover, particularly with the substantially parallel, yet mutually overlapping arrangement of the iron(III) oxide particles due to differently sized plate-like particles, there is hardly any pathway for unintentionally penetrating and harmful substances, which is of importance with respect to the barrier and shielding effect of the coating. Likewise, the alignment of the plate-like particles results in a higher packing density, which is also advantageous in terms of the impermeability of the coating.

The grain size distribution can be recognised in the final product and measured in a simple manner, e.g. by way of microscopy. There are substantially no monograms, i.e. particles of substantially equal or similar grain size, but much rather partides are found which are unequal in size, whereby differently sized grains are distributedly and/or overlappingly provided in the final product. The grain distribution of the natural iron(III) oxide may, e.g., also be studied by way of a grain sum curve, wherein the d₁₀, the d₅₀ and/or the d₉₈ value (arithmetic values which are commonly used in practice for judging such a product) typically are different (are in an unequal relationship to each other), whereas substantially equal values are to be attributed to monograms and, thus, correspond to synthetic iron(III) oxide. Natural, mechanically processed plate-like Fe mica particles exhibit also distinctive fracture characteristics which are derived from their natural mineral structure and easily recognizable. Furthermore, typical of natural iron(III) oxide is the presence of intergrowths with phases of different mineralogy and/or the presence of accompanying minerals. For instance, intergrowths with silicates, carbonates etc. are found which may also be provided as single grains (accompanying minerals). In some samples of the natural iron(III) oxide of the invention the portion of accompanying minerals may be in the range of up to 10 or even 15%. Depending on the field of application, the portion of the accompanying minerals may be reduced, e.g. by removal of at least the majority of the accompanying minerals, or it may also be kept.

Adhering to the desired maximum particle size and the optimum particle size distribution for the final product can be checked in conventional manner, e.g. by way of a grading curve. It is in their nature that the particle sizes may also be in the submicron range. Depending on the field of application, the iron(III) oxide may be provided in any particle bands desired. Thus, e.g., ranges of from 1 μm to 3 μm, 5 μm to 10 μm, or other ranges—also ranges of finer grain sizes—may be preferred. Of course, also particle bands in the submicron range can be provided.

It may be desired for the final product to contain about 90% by weight of lamellar iron(III) oxide smaller than 10 μm. In coatings, such as varnishes or the like coats of paint, this may, e.g., be of particular advantage since the barrier effect, the shielding effect and the abrasion resistance can be further improved. Also the resistance to mechanical wear, fluctuating ambient conditions, such as temperature, humidity, dryness and the like, can be markedly increased. When adhering to the particle size distribution, a high packing density of the iron(III) oxide particles, e.g. in varnishes, can be achieved, whereby the varnish becomes additionally more resistant to mechanical wear.

According to a further feature of the invention, the iron(III) oxide can also be present in a particle size of smaller or ≦5 μm. It should be noted that the maximum grain size of the iron(III) oxide of the invention may vary within the sizes defined according to the invention, depending on the application and desired quality of the final product.

For indicating as well as characterising the lamellar structure of iron(III) oxide, the aspect ratio can be employed. Within the scope of the invention, by this the ratio of the largest diameter to the thickness or height of a particle (lamella) of an iron(III) oxide grain is to be understood. For determining the aspect ratio, preferably an iron(III) oxide particle from the largest grain range is used. According to the invention, an aspect ratio [largest diameter/thickness] of the lamellae of the iron(III) oxide of substantially 20:1, preferably 5:1, is particularly advantageous with a view to an increased applicability.

When employing the iron(III) oxide according to the invention for coatings, in particular for thin film applications, it is, thus, conceivable that a plate-like iron(III) oxide particle having a layer thickness, i.e. thickness of the plate-like particle, of 2 μm, is chosen and employed for a coating with a coat thickness of approximately 15 μm. According to this example, it may even happen that the coating has up to 3 to 5 or even more layers of plate-like iron(III) oxide particles, the Fe particles being provided in an orientation substantially in parallel with the substructure of the coating.

According to an alternative feature within the scope of the invention, an iron(III) oxide of synthetic origin may be admixed to the iron(III) oxide. Suitably, the synthetic iron(III) oxide has said lamellar structure; preferably, it is also in the inventive maximum grain size. Advantageously, it also has an aspect ratio which is equal or similar to that of the natural iron(III) oxide according to the invention. In this way, a mixture of natural and synthetic Fe mica is provided. This may be advantageous if for a particular application it is, e.g., desired that a certain particle size should be dominant in the grain band, and this is more easily obtainable by using iron(III) oxide of synthetic origin. In this instance, it is, e.g., conceivable that such a mixture comprises approximately up to 10% or even up to 15% of synthetic iron(III) oxide.

As regards providing the synthetic iron(III) oxide, various methods known per se—such as also implied above—are conceivable. Also the thermolysis of iron compounds, starting out, e.g., with iron sulfate, or oxidative methods in aqueous media, such as the Penniman-Zoph method or the aniline method may be employed, which methods are commonly used for the production of iron(III) oxide as a pigment. Synthetic iron(III) oxide can also be produced by dissolution of, e.g., iron scrap in a suitable acid and subsequent controlled precipitation under pressure and in an protective gas—(e.g. nitrogen—) atmosphere.

As an alternative, the iron(III) oxide can be grown by crystal growth, typically from an iron oxide solution under conditions known per se. The iron(III) oxide crystals are grown up to the desired maximum particle size of the invention. It is even conceivable to grow the crystals to larger crystals, whereupon they are mechanically broken down to the particle size limit of the invention. During crystal growing, suitably—depending on their application—attention should be paid to the formation and retention of the lamellar structure of the iron(III) oxide crystals.

The object of the invention is, furthermore, achieved in that a method for producing the lamellar iron(III) oxide according to the invention is provided in which the iron(III) oxide is crushed to the particle size of the invention in an impact crusher, such as by means of a jet mill known per se. In this instance, a vapour expansion may, e.g., be employed for accelerating the iron(III) oxide particles in the mill.

Alternatively, it is conceivable that the iron(III) oxide is subjected to a shearing stress, such as by means of a shear mill known per se. In the course of such processing, the iron(III) oxide particles are crushed by friction.

It has been shown that these aforementioned methods constitute a gentle, effective and low-cost mechanical processing of the iron(III) oxide particles for achieving the desired particle size, while maintaining the lamellar structure of the grains. Surprisingly, this has been particularly found when using a jet mill.

Following this mechanical processing it is suitable to separate the iron(III) oxide into particle fractions, particle ranges or particle bands. In this form, the iron(III) oxide of the invention thus can be provided for further processing. Sifting devices, such as pneumatic air separators, centrifugal force separators and the like, or also other fractionating and separating devices may be employed.

With regard to a use of the iron(III) oxide of the invention, there exist numerous options. It has been found that the iron(III) oxide of the invention is just as suitable in coatings, such as varnishes, for protecting substructures against corrosion, as it is in coatings for protecting substructures against mechanical wear, or in coatings which are intended to protect the substructure from light, i.e. UV, IR light. It could be found out that by the iron(III) oxide according to the invention, the adherence of the coating on the substructure to be coated can be greatly improved even in intermediate layers of the coating. The protective properties, in general, can be greatly enhanced, irrespective of the type of binder for the iron(III) oxide. In this way, the load bearing capacity and, thus, also the useful life of the coating can be enhanced. As substructures, metal or non-metal surfaces, objects and many other things are to be understood. It has been shown that the iron(III) oxide according to the invention is particularly effectively suitable as a pigment in varnishes, colours and the like, e.g. for outdoor steel structures.

Likewise, by means of the iron(III) oxide according to the invention, the optic effect, the metallic gloss, e.g., of coatings, i.e. of decorative coatings, for objects, such as boats, surfboards, decorative objects, electric appliances and many other things can be obtained and/or also enhanced.

The field of application of the iron(III) oxide of the invention is, however, not restricted to coatings, but it may even extend to a use as filler in synthetic material products. As synthetic material products, e.g. polyethylene, polypropylene, polyamide, fiber-glass reinforced synthetic materials and other substances may be considered.

Moreover, surprisingly it could be found that the properties of the iron(III) oxide of the invention with regard to barrier effect, shielding effect, protection against mechanical wear, optic effect and the like could be particularly well utilised in products of the ceramics industry. Thus, the iron(III) oxide of the invention is excellently suited as an additive, e.g. as a pigment, in ceramics materials, which are employed e.g. for the production and/or the treatment of products for sanitary purposes, such as tiles, wash-basins and the like, in particular the surfaces thereof.

In addition to these aforementioned possible applications, the iron(III) oxide according to the invention lends itself to a large number of other applications in which the lamellar structure of iron(III) oxide in the low particle size range is of advantage.

In the following, the invention will be explained in more detail by way of exemplary embodiments illustrated in the drawings.

Therein,

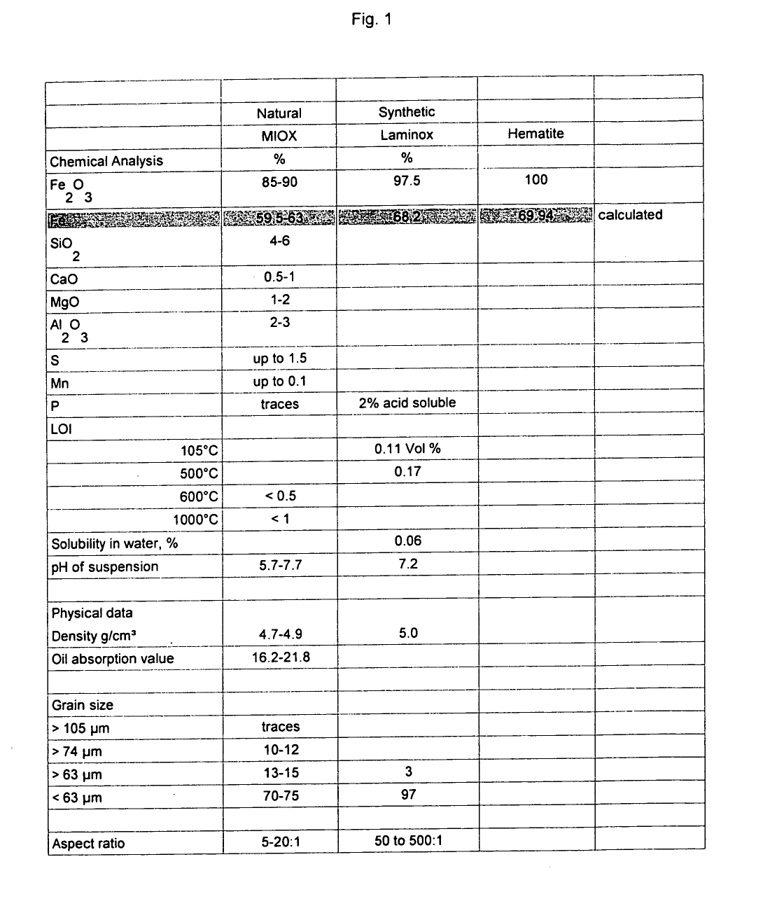

FIG. 1 shows a comparison of iron(III) oxides of natural and synthetic origins in the form of a table;

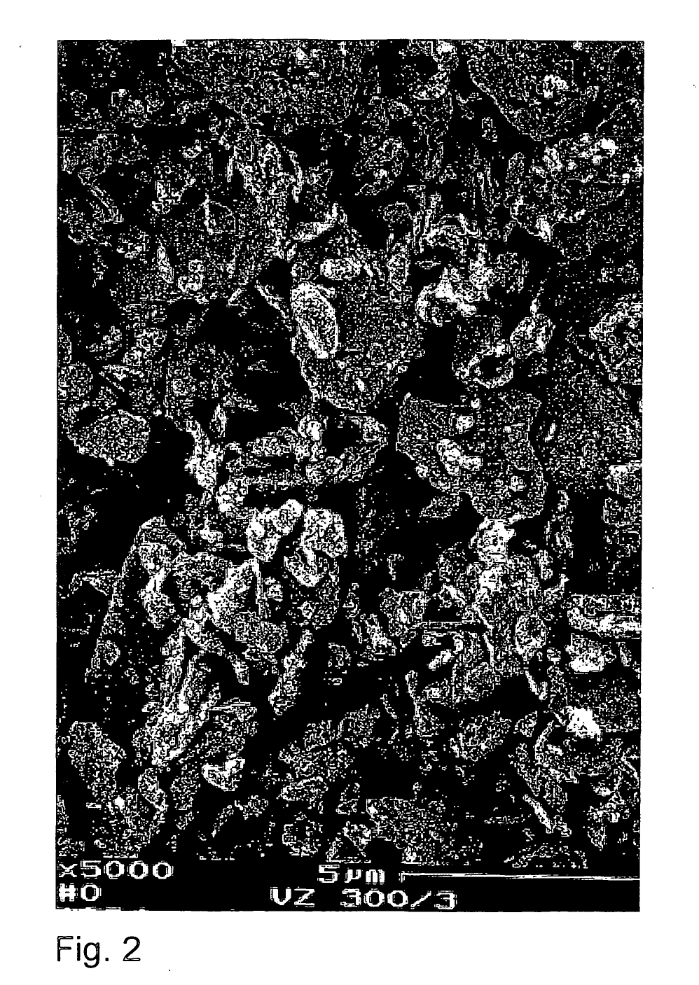

FIG. 2 shows an image taken by an electron microscop of a sample of the iron(III) oxide according to the invention, magnified 5000 times;

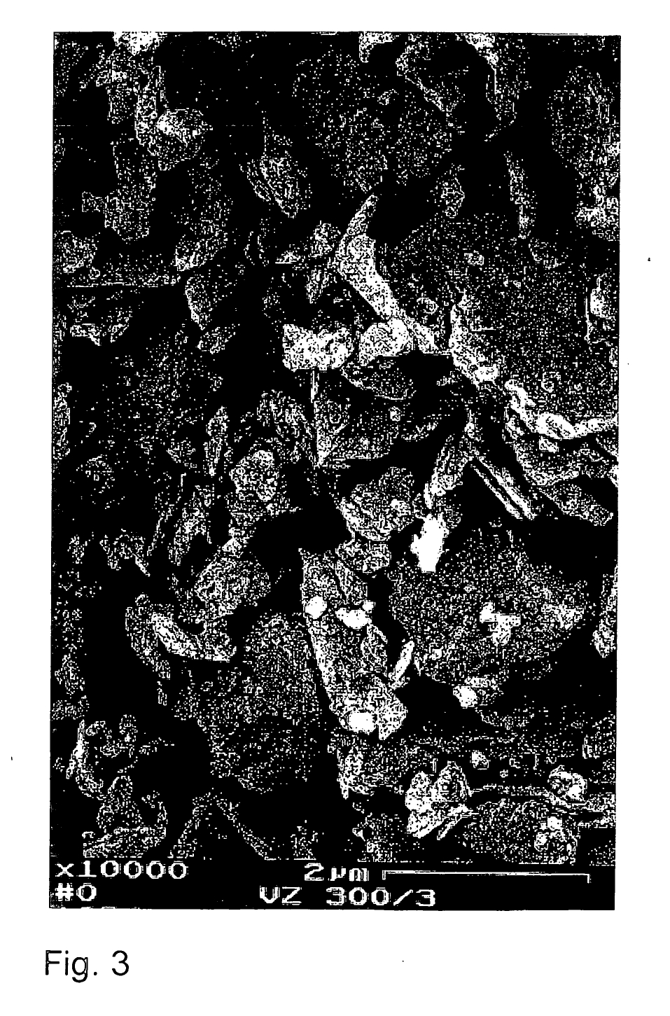

FIG. 3 shows an image taken by an electron microscop of a sample of the iron(III) oxide according to the invention, magnified 10000 times; and

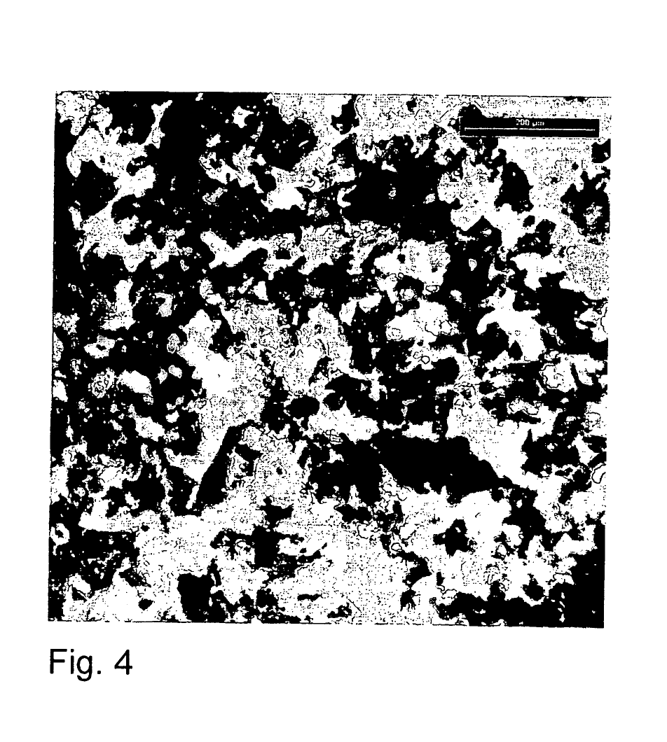

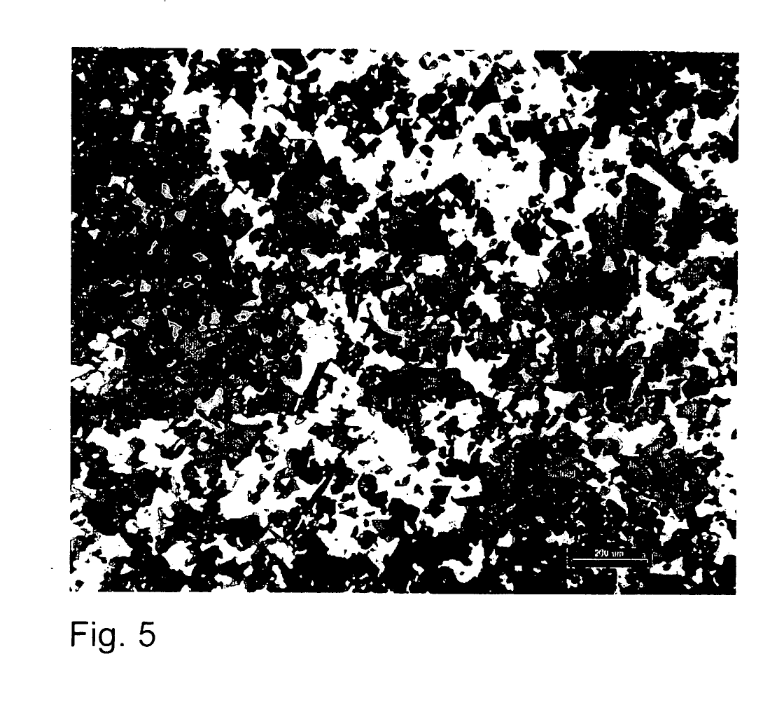

FIGS. 4 to 6 show further images taken by an electron microscope of a sample of the iron(III) oxide according to the invention.

In detail, FIG. 1 shows a table in which the results of diverse examinations of a sample of natural iron(III) oxide and of a sample of synthetic iron(III) oxide are compared with each other. The examinations included chemical and physical analyses; among them also a sedimentologic method (grain size analysis). It should be noted here that the examined sample of the natural iron(III) oxide is not an iron(III) oxide according to the invention. The illustration shall essentially show the difference between natural and synthetic iron(III) oxides.

From the results of the chemical analysis according to FIG. 1 it is visible that the data belonging to the natural iron(III) oxide also contain portions of other substances or elements in addition to Fe₂O₃, or Fe, respectively. The synthetic iron(III) oxide has a degree of purity of up to 97% by weight. The data regarding the grain sizes show that with natural iron(III) oxide there exists a grain band, i.e. grains of various particle size, while the synthetic iron(III) oxide is mainly comprised of mono-grains, i.e. substantially one grain size is dominant. Differences between the two types of iron(III) oxide also appear in the aspect ratio.

FIG. 2 shows an image of a sample of the iron(III) oxide according to the invention, taken by an electron microscope and magnified 5000 times. Likewise, in FIG. 3 an image of a sample of the iron(III) oxide according to the invention taken by an electron microscope can be seen, yet here this sample is shown magnified 10000 times. By indicating the scale in both figures, it becomes clear that the grains are below the 10 μm limit. Moreover, it is visible that the large majority, approximately 90%, of the iron(III) oxide particles have an excellently maintained, intact plate-like shape—despite mechanical processing. Likewise, a distribution of the particle sizes can be seen.

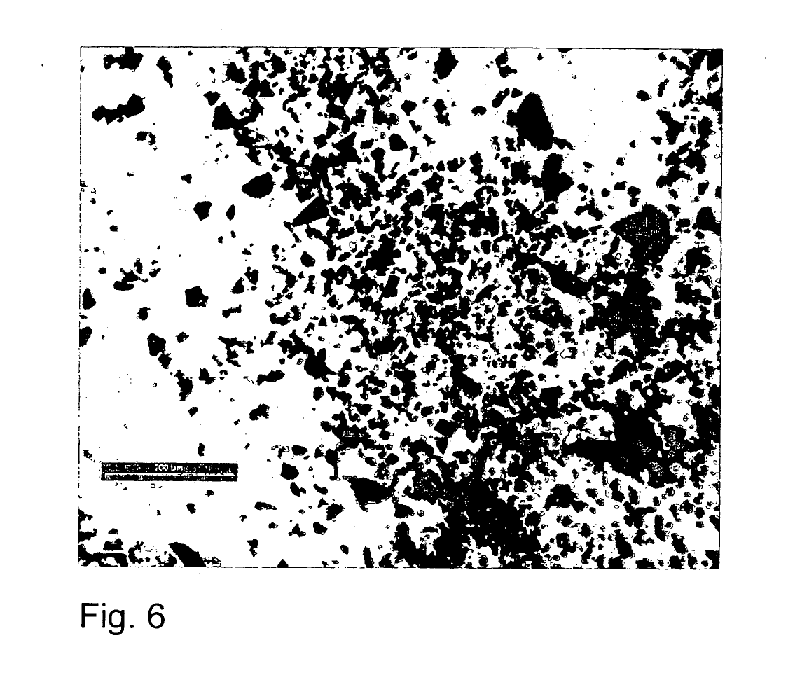

The grain distribution, size of the individual particle, partially the layer thickness as well as the plate-like shape of the iron(III) oxide grains according to the invention is furthermore illustrated by way of the images according to FIG. 4 and FIG. 6, and in these images a scale of 200 μm is indicated. In FIG. 4, the intergrowths of the Fe mica particles with other minerals, partly formed on account of the genesis of natural iron(III) oxide, are visible, these mainly being silicates.

By means of the iron(III) oxides of lamellar structure according to the invention, much thinner film layers can be obtained than has hitherto been possible which, nevertheless, meet the high specific demands in terms of barrier effect, shielding effect, load bearing capacity, durability as well as in terms of costs and economic efficiency.

1-13. (canceled)

14. An iron(III) oxide, comprising:
mechanically processed iron(III) oxide of natural origin and having a lamellar structure of at least 50% by weight, and having a component part of at least 50% by weight of iron(III) oxide particles with a particle size of smaller than 10 μm.

15. The iron(III) oxide according to claim 14, wherein said lamellar structure iron(III) oxide is at least 75% by weight.

16. The iron(III) oxide according to claim 14, wherein said component part with a particle size of less than 10 μm is greater than 70% by weight.

17. The iron(III) oxide according to claim 14, wherein said component part with a particle size of less than 10 μm is greater than 90% by weight.

18. The iron(III) oxide according to claim 14, wherein said iron(III) oxide has a particle size of <or ≦5 μm.

19. The iron(III) oxide according to claim 14, wherein an aspect ratio, defines as a largest diameter over a thickness of the lamellae of the iron(III) oxide lies in a range of between 20:1 and 5:1.

20. The iron(III) oxide according to claim 19, wherein the aspect ratio is substantially 10:1.

21. The iron(III) oxide according to claim 19, which comprises a component of iron(III) oxide of synthetic origin admixed to the component of natural origin.

22. The iron(III) oxide according to claim 21, wherein said iron(III) oxide of synthetic origin is an oxide produced by crystal growing.

23. A method for producing lamellar iron(III) oxide, the method which comprises:
mechanically processing iron(III) oxide of natural origin in an impact crusher to form processed iron(III) oxide having a lamellar structure of at least 50% by weight and having at least 50% by weight of iron(III) oxide particles with a particle size of smaller than 10 μm.

24. The method according to claim 23, which comprises processing the iron(III) oxide in a jet mill.

25. The method according to claim 23, which comprises, subsequent to the mechanical processing, separating the iron(III) oxide into particle or grain bands, respectively.

26. A production method, which comprises providing the iron(III) oxide according to claim 14, and producing therewith coating configured for protecting substructures against corrosion.

27. The production method according to claim 26, wherein the coating is a varnish.

28. A production method, which comprises providing the iron(III) oxide according to claim 14, and producing therewith coatings configured for protecting substructures against mechanical wear.

29. The production method according to claim 26, wherein the coating is a varnish.

30. A production method, which comprises providing the iron(III) oxide according to claim 14, and producing therewith coatings configured as a light shield for substructures.

31. The production method according to claim 26, wherein the coating is a varnish.

32. A production method, which comprises providing the iron(III) oxide according to claim 14, and producing therewith decorative coatings for objects.

33. The production method according to claim 24, which comprises specially formulating the decorative coating for boats, surfboards, or decorative objects.

34. A production method, which comprises providing the iron(III) oxide according to claim 14, and admixing the iron(III) oxide as a filler in synthetic material products.

35. The production method according to claim 26, which comprises admixing the iron(III) oxide as a filler in polyethylene, polypropylene, polyamide, or fiber-glass reinforced synthetic materials.

36. A production method, which comprises providing the iron(III) oxide according to claim 14, and admixing the iron(III) oxide as a an additive in ceramics materials.
